(19) United States
(12) Patent Application Publication
(10) Pub. No.: US 2014/0125875 A1
(43) Pub. Date: May 8, 2014

(54) VIDEO DISPLAY DEVICE AND VIDEO DISPLAY SYSTEM

(71) Applicant: Kabushiki Kaisha Toshiba, Tokyo (JP)

(72) Inventors: Yoshiharu Momonoi, Kanagawa (JP); Tatsuo Saishu, Tokyo (JP)

(73) Assignee: Kabushiki Kaisha Toshiba, Tokyo (JP)

(21) Appl. No.: 13/894,787

(22) Filed: May 15, 2013

(30) Foreign Application Priority Data
Nov. 5, 2012 (JP) 2012-243948

(51) Int. Cl. H04N 5/64

(52) U.S. Cl. CPC H04N 5/64
USPC 348/836

(57) ABSTRACT

According to one embodiment, a video display device includes a display module, a frame, and an optical element. The frame is provided to an outer circumference of the display module. The optical element is provided on the frame and to a portion of an area on the display module including a border between the frame and the display module. The optical element is configured to enlarge a video image output from the display module in a direction from the display module towards the frame for an outer circumferential area including the frame, and to enlarge the video image output from the display module in a direction from the frame towards the display module for an inner circumferential area on an inner side with respect to the outer circumferential area.

### CROSS-REFERENCE TO RELATED APPLICATIONS

This application is based upon and claims the benefit of priority from Japanese Patent Application No. 2012-243948, filed Nov. 5, 2012, the entire contents of which are incorporated herein by reference.

### FIELD

An embodiment described herein relates generally to a video display device and a video display system.

### BACKGROUND

Since making of a large-size video display device is costly, there has been existing a technology in which a plurality of video display devices are arranged next to one another to configure a large-size screen as a whole.

A display module of the video display device has an outer frame on the outer circumference thereof, and when the video display devices are arranged next to each other, a seam by the outer frames is therefore formed between the video display devices. This has lead to develop a technology in which a lens is disposed in front of the display module to enlarge a video image with the lens in the direction toward the outer frame so as to reduce the width of the seam visible to a viewer.

The conventional technology to reduce the width of the seam by magnification with the lens, however, does not consider the viewer viewing from a direction other than the front side.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram of an example of a four-screen tiled display composed of four video display devices according to an embodiment;

FIG. 2 is an exemplary diagram of an example of areas of optical elements provided on the respective video display devices in the embodiment;

FIG. 3 is an exemplary diagram of arrangement of the optical elements provided in a horizontal direction to cover a seam in a first display area in FIG. 2 in the embodiment;

FIG. 4 is an exemplary diagram of the arrangement of the optical elements provided to cover crossing seams in a second display area in FIG. 2 in the embodiment;

FIG. 5 is an exemplary diagram of display areas of scaled-down images output to cover the seam in the first display area in FIG. 2 in the embodiment;

FIG. 6 is an exemplary diagram of display areas of scaled-down images output to cover the seams in the second display area in FIG. 2 in the embodiment;

FIG. 7 is an exemplary diagram of a concept of display by the respective video display devices in the embodiment;

FIG. 8 is an exemplary diagram of an optical system provided to a surface of the respective video display devices in the embodiment; and

FIG. 9 is an exemplary diagram for explaining mathematical expressions for the optical system provided on the surface of the respective video display devices in the embodiment.

### DETAILED DESCRIPTION

In general, according to one embodiment, a video display device comprises a display module, a frame, and an optical element. The frame is provided to an outer circumference of the display module. The optical element is provided on the frame and to a portion of an area on the display module including a border between the frame and the display module. The optical element is configured to enlarge a video image output from the display module in a direction from the display module towards the frame for an outer circumferential area including the frame, and configured to enlarge the video image output from the display module in a direction from the frame towards the display module for an inner circumferential area on an inner side with respect to the outer circumferential area.

With reference to the accompanying drawings, an exemplary embodiment of a video display device and a video display system according to the present invention will be described hereinafter. While the following embodiment illustrates an example of a video display device and a video display system, the embodiment may be in other forms.

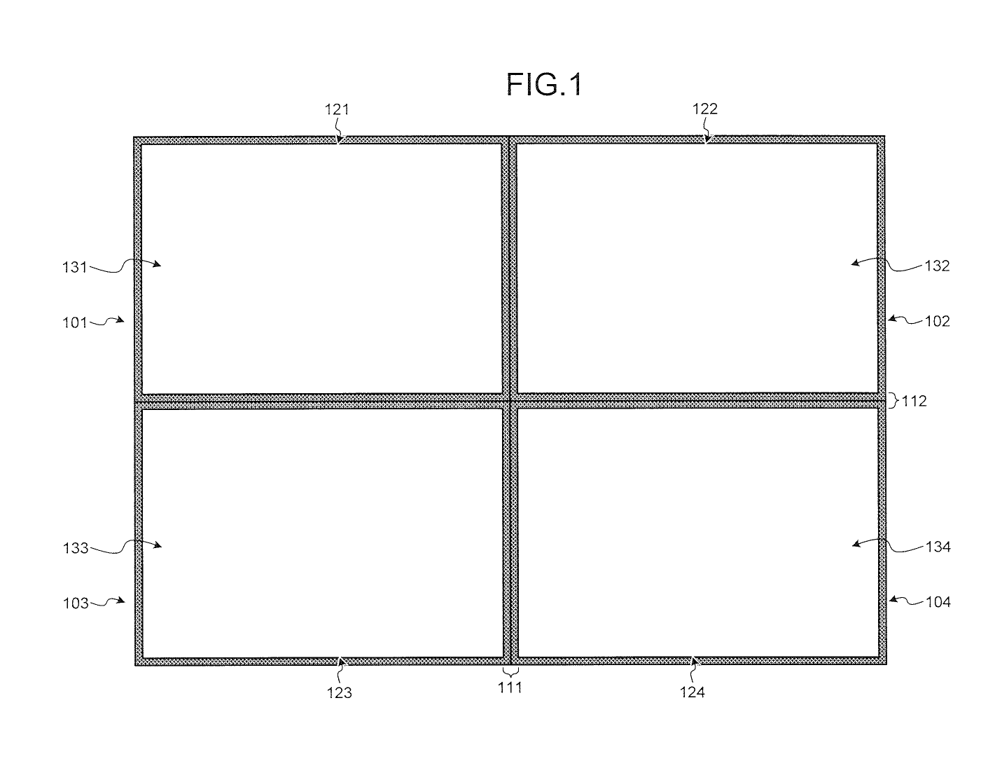

FIG. 1 is a diagram illustrating an example of a four-screen tiled display that is one form of the video display system composed of four units of video display devices according to the present embodiment.

In the example illustrated in FIG. 1, four units of video display devices 101, 102, 103, and 104 are composed of display modules 131, 132, 133, and 134, and outer frames 121, 122, 123, and 124 provided on the outer circumference of the respective display modules 131, 132, 133, and 134.

In the example illustrated in FIG. 1, the four video display devices 101 to 104 are arranged in a tiled fashion and are used as a single large-size screen display. The four-screen tiled display in the present embodiment comprises the video display devices arranged in two rows each in the horizontal direction and in the vertical direction.

Here, the present embodiment is not intended to restrict the arrangement as such, and the video display devices may be arranged in three rows or more, or may be arranged only in the horizontal direction or in the vertical direction.

As illustrated in FIG. 1, when the four video display devices 101, 102, 103, and 104 are arranged, seams 111 and 112 by the outer frames 121 to 124 are formed in a cross shape.

In other words, when a large-screen display is made with the four video display devices 101, 102, 103, and 104, the screen is interrupted by the seams 111 and 112. Therefore, according to the present embodiment, optical elements are provided for each of the video display devices 101, 102, 103, and 104 and provided on the outer frame and to a portion of an area on the display module including a border between the outer frame and the display module. Then, video images output from the video display devices 101, 102, 103, and 104 are displayed in an enlarged manner so as to make the outer frames look narrower or invisible to the viewer. This allows the four video display devices 101, 102, 103, and 104 to display the video images as a single continuous display.

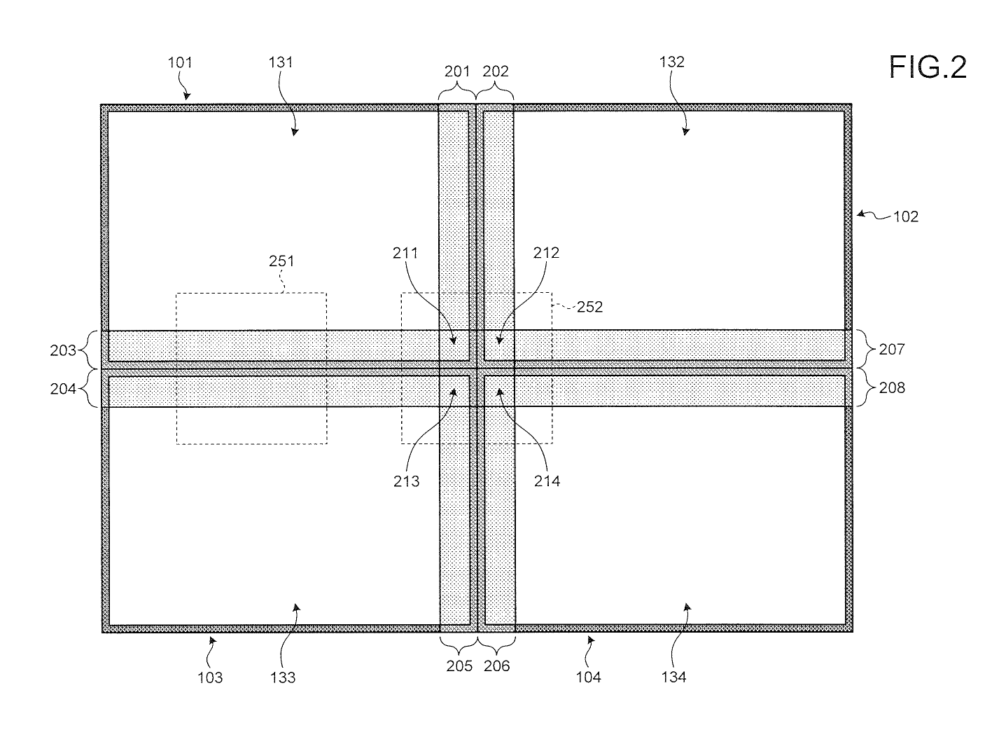

FIG. 2 is a diagram illustrating areas of the optical elements provided on the respective video display devices 101 to 104 in the embodiment. In the example illustrated in FIG. 2, the optical elements are arranged on respective areas 201 to 208 that are the outer frames 121 to 124 of the four video display devices 101, 102, 103, and 104 and portions of the display modules 131 to 134 thereof. Out of the areas 201 to 208, at the portions that do not intersect with the areas of the other optical elements, provided are linear lenses (having a curvature in a one-dimensional direction) that enlarge a video image in a direction perpendicular to a border line between two of the video display devices 101 to 104. As for the linear lens, a cylindrical lens, for example, is conceivable. However, other optical systems may be used.

Meanwhile, in areas 211 to 214 at which a plurality of areas of the optical elements intersect, provided are circular lenses that enlarge a video image in the vertical direction and in the horizontal direction (two-dimensional area).

The optical system (optical elements) illustrated in FIG. 2 is provided at the outer frames of the four video display devices 101, 102, 103, and 104 and at the portions of the areas of the display modules thereof, and enlarges video images output from the display modules.

As illustrated in FIG. 2, the optical elements provided on each of the four video display devices 101, 102, 103, and 104 enlarge the video image in a direction from the display module towards the outer frame (in either one or more of the horizontal direction and the vertical direction) at the periphery of the outer frame adjoining to the other video display devices.

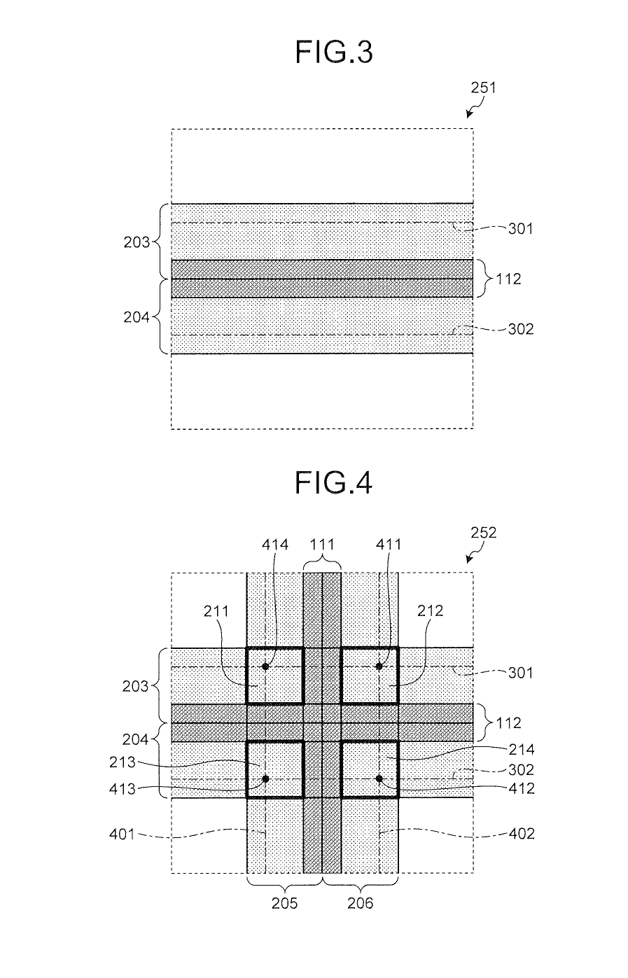

FIG. 3 is a diagram illustrating arrangement of the optical elements provided in the horizontal direction to cover the seam 112 in a first display area 251 in FIG. 2. In the example illustrated in FIG. 3, the optical elements (lenses) are provided to the areas 203 and 204 that include the outer frames 121 and 123 and portions on the display modules 131 and 133, respectively. The optical element has an optical axis 301 in the area 203, and has an optical axis 302 in the area 204. For an outer circumferential area of the area 203 on an outer frame 121 (seam 112) side from the optical axis 301, the optical element enlarges the video image output from the display module 131 in a direction from the display module 131 towards the outer frame 121. For an inner circumferential area of the area 203 on an inner side from the optical axis 301, the optical element enlarges the video image output from the display module 131 in a direction from the outer frame 121 towards the display module. In the area 204, the enlargement line-symmetrical to the area 203 is made.

In the example illustrated in FIG. 3, with reference to the border between the upper and lower video display devices 101 and 103, the optical elements (lenses) are arranged line-symmetrically. In the area of the seam 112, the optical elements (lenses) display scaled-down image data in an enlarged manner. Consequently, the video images are displayed seamlessly.

FIG. 4 is a diagram illustrating arrangement of the optical elements provided to cover the crossing seams 111 and 112 in a second display area 252 in FIG. 2. In the example illustrated in FIG. 4, the optical elements are provided in the areas 203, 204, 205, and 206. The optical element (lens) has an optical axis 401 in the area 205, and the optical element (lens) has an optical axis 402 in the area 206. For an outer circumferential area of the area 205 on an outer frame (the seam 111) side from the optical axis 401, the optical element enlarges the video image output from the display module 133 in a direction from the display module 133 towards the outer frame 123 (the seam 111). For an inner circumferential area on an inner side from the optical axis 401, the optical element enlarges the video image output from the display module 133 in a direction from the outer frame 123 towards the center of the display module 133 (the seam 111).

Intersections of extended lines of the optical axes 301, 302, 401, and 402 of the linear lenses form centers of the lenses. The circular lens in the area 211 enlarges the video image with reference to a center 414 of the lens. The circular lens in the area 212 enlarges the video image with reference to a center 411 of the lens. The circular lens in the area 213 enlarges the video image with reference to a center 413 of the lens. The circular lens in the area 214 enlarges the video image with reference to a center 412 of the lens. In each of the areas 211 to 214, the lens thus constitutes a two-dimensional enlarging optical system.

In the video display devices, the display modules output scaled-down image data that is assumed to be enlarged by the optical elements. Next, the areas to which the scaled-down image data is output will be described.

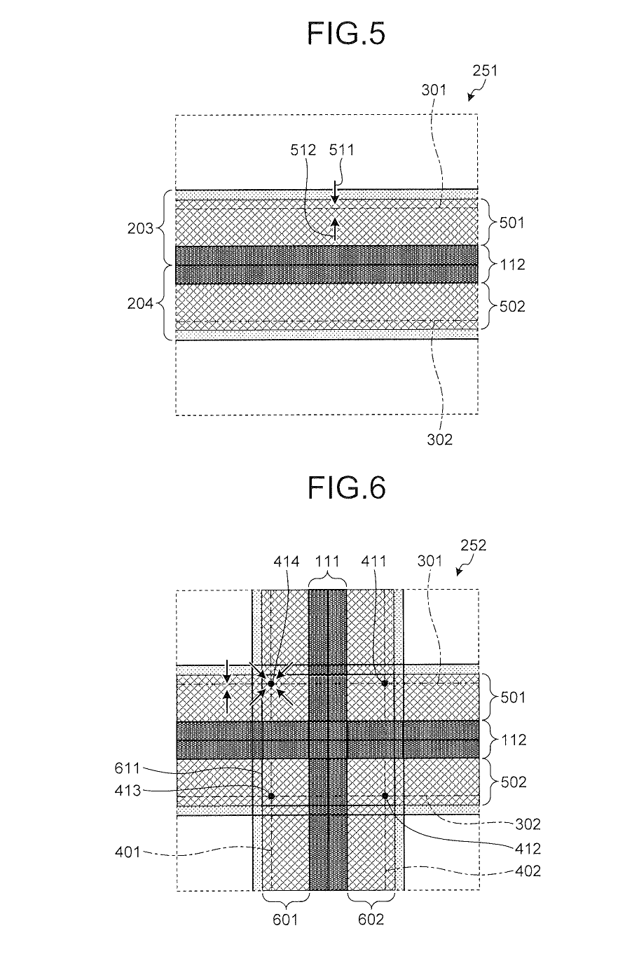

FIG. 5 is a diagram illustrating display areas of scaled-down images output to cover the seam 112 in the first display area 251 in FIG. 2.

In the example illustrated in FIG. 5, the scaled-down image data is output from display areas 501 and 502. The scaled-down image data is scaled down in directions of arrows 511 and 512 centered around the optical axis 301 of the optical element. In other words, the scaled-down image data is enlarged in directions opposite the arrows 511 and 512 centered around the optical axis 301 by the optical element disposed in the area 203. This makes the seam 112 invisible to the viewer, and the scaled-down image data is also enlarged in a direction toward inside of the display module 131 of the video display device 101. A scale-down factor of the scaled-down image data corresponds to an enlargement factor of the area 203 enlarged by the optical element. As a result of the scaled-down image data thus enlarged by the enlargement factor, the viewer recognizes the video image as a normal video image.

FIG. 6 is a diagram illustrating display areas of the scaled-down images output to cover the seams 111 and 112 in the second display area 252 in FIG. 2.

In the example illustrated in FIG. 6, the scaled-down image data is output from the display areas 501 and 502 similarly to those in FIG. 5, and from display areas 601 and 602 in addition. In a display area 611 in which the display areas 501 and 502 and the display areas 601 and 602 overlap, the scaled-down image data is scaled down both in the vertical direction and in the horizontal direction (two-dimensional direction). For example, the scaled-down image data output from the video display device 101 is scaled down in arrow directions with reference to a center 414 of the lens (optical element). The scaled-down image data is enlarged by the optical element, similarly to those in FIG. 5, in directions opposite the arrows with reference to the center 414 of the lens.

In the example illustrated in FIG. 6, the four video display devices 101 to 104 have the lenses (optical elements) arranged point-symmetrically to a contact point as the point of symmetry. Consequently, the scaled-down image data of the other video display devices 102 to 104 are scaled down with reference to the centers 411 to 413 of the respective lenses.

In the video display devices 101 to 104, the scaled-down image data is enlarged up to the area of the outer frame by the respective optical elements. This allows each of the video display devices 101 to 104 to seamlessly connect the video image to the contact point. As a consequence, the seams 111 and 112 can be made invisible to the viewer.

As described above, in the video display devices 101 to 104, an area that outputs the scaled-down image data from among the display area at which the respective display modules 131 to 134 display the video images is smaller than an area of the lens at which the scaled-down image data is projected.

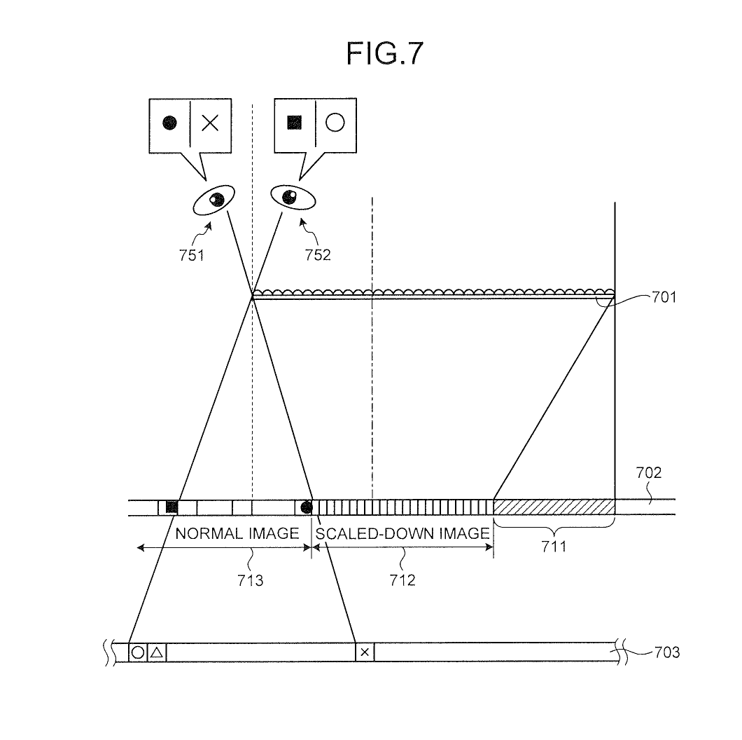

Next, the reason to enlarge the scaled-down image data in the direction toward a side of the optical axis opposite the seams and toward an inner side the display module of the respective video display devices 101 to 104 by an optical element will be described. FIG. 7 is a diagram illustrating the concept of display by the respective video display devices 101 to 104. In the example illustrated in FIG. 7, an optical element 701 is exemplified to be provided at a position separated from a display module 702 by a predetermined distance. Furthermore, illustrated is a virtual image 703 displayed in an enlarged manner by the optical element 701. The predetermined distance is defined by a specific embodiment of implementation.

In the display module 702, there are an area 713 that outputs normal image data, an area 712 that outputs scaled-down image data, and an outer frame 711. The scaled-down image data is displayed in an enlarged manner by the optical element 701 such that the outer frame 711 is invisible to the viewer.

As illustrated in FIG. 7, the scaled-down image data is enlarged by an optical element not only in the outside direction toward which the outer frame 711 is arranged but also in the direction toward inside the display module 702. Supposing that the scaled-down image data is not enlarged in the inside direction, although not depicted, the scaled-down image data becomes visible to the viewer when the viewer looks into the video display device 101 from a center thereof towards the outer frame direction. On the other hand, when the viewer looks into the display module from the opposite direction (in a direction towards the center of the video display device 101 from the outer frame side thereof), a normal image enlarged by the optical element is visible to the viewer. In other words, an image with a different enlargement factor become visible at a portion of the image when the video display device 101 is viewed from an angle other than an angle perpendicular to the video display device 101. In the present embodiment, the scaled-down image data is therefore enlarged by an optical element in the inside direction. Consequently, the virtual image 703 is displayed in an enlarged manner by the optical element 701, and up to the area indicated by ◯ is displayed in an enlarged manner. Because the optical element enlarges the portion of the image in the direction toward the side of the optical axis opposite the seams and toward the inner side of the display module 702, the area 713 which outputs the normal image data can be provided below the optical element and up to the area indicated by .

For example, even when the viewer looks into the display module from a viewpoint 751 (in other words, in a direction towards the outer frame 711 from the center of the video display device 101), the area 713 to which normal image data is output is present behind the optical element. Thus, it can be prevented that the scaled-down image data becomes visible, thereby the video image data can be displayed as intended by a producer of the video image data without interruption. Even when the viewer looks into the display module from a viewpoint 752 in the opposite direction (in other words, in a direction towards the center of the video display device 101 from the outer frame side thereof), the virtual image 703 displayed in an enlarged manner by the optical element 701 is present. Thus, it can be prevented that the normal image is enlarged and becomes visible, thereby the video image data can be displayed as intended by the producer of the image data without interruption. Furthermore, the display module 702 displays an overlapping video image (also referred to as an overlapping area) included between the normal image data and the scaled-down image data so that the viewer can view the video image appropriately even when viewed from an angle other than the front side. Consequently, the video image can be viewed appropriately even when viewed from the viewpoint 751 and the viewpoint 752. More specifically, between the viewpoint 751 and the viewpoint 752 designed, the viewer can view the scaled-down image data enlarged (by repressing the enlargement of the normal image data) as the image data through the optical element 701 and can view the normal image data (by repressing the view of the scaled-down image data) as the image data not through the optical element 701.

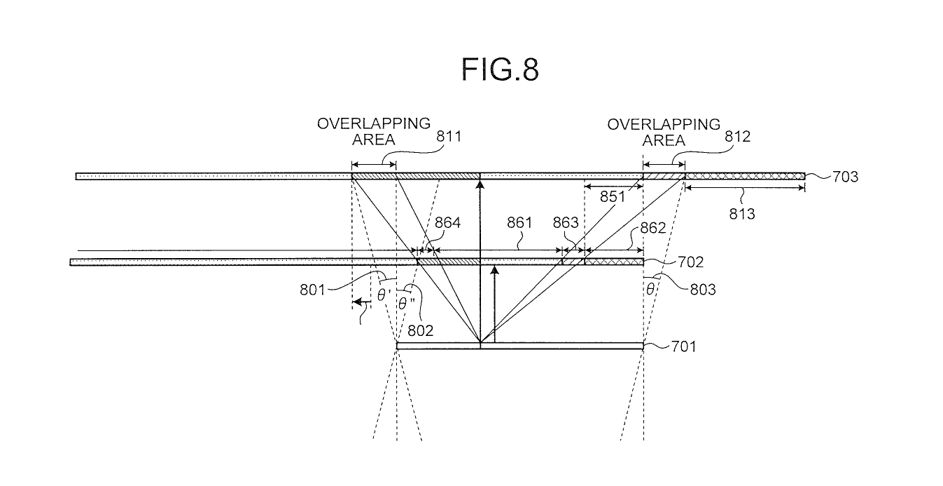

FIG. 8 is a diagram illustrating the optical system provided on the surface of the respective video display devices 101 to 104. In the example illustrated in FIG. 8, depicted are the optical element 701, the display module 702 including an outer frame 862, and the virtual image 703 displayed in an enlarged manner by the optical element 701.

The thin optical element (lens) 701 enlarges the scaled-down image data output from an area 861 of the display module 702. As in the foregoing, in the present embodiment, the thin optical element 701 is arranged on the outer frame 862 over to the area 861. The optical element 701 then enlarges the scaled-down image data output from the area 861 of the display module 702. An enlarged virtual image 851 of the scaled-down image data makes the outer frame 862 invisible. An area 813 of the virtual image 703 is the area in which the outer frame 862 is displayed in an enlarged manner.

Furthermore, an overlapping area 812 is provided to make the outer frame 862 invisible when the viewer observes the display module 702 at an angle 803 of θ. The image data corresponding to the overlapping area is output to an area 863 calculated in advance as the scaled-down image data.

Furthermore, the scaled-down image data that an area 864 outputs is made to overlap the normal image data output in the normal image area so as to avoid the appearance of discontinuity in the video image when the viewer observes the display module at an opposite angle 801 of θ′. An overlapping area 811 thus provided avoids the appearance of the discontinuity, whereby the video image can be displayed without interruption between an angle 802 of θ″ and the angle 801 of θ′.

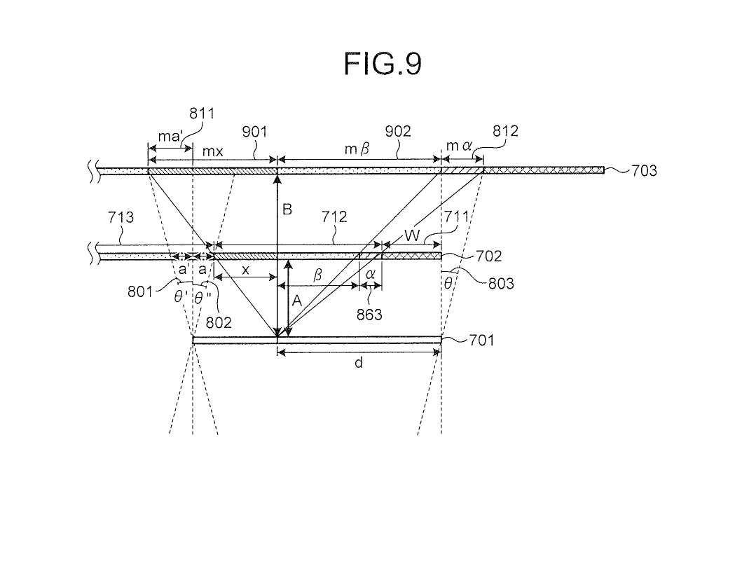

FIG. 9 is a diagram for explaining mathematical expressions for the optical system provided on the surface of the respective video display devices 101 to 104. The following is merely an example, and other embodiments may be implemented.

When the magnification ratio of the lens is defined as m, lengths x, β, α, and ma′ included in the area 712 to which the scaled-down image data is output are displayed in the virtual image 703 as a length mx in an area 901, as a length mβ in an area 902, as a length ma in the overlapping area 812, and as a length ma' in the overlapping area 811.

The magnification ratio of the lens m can be obtained by the following Expression (1) based on a distance din the outer frame 711 direction from the center of the lens 701 of the lens 701 and the length β from the center of the lens 701 not including the overlapping portion of the scaled-down image area.

m=d/β (1)

The length d from the center of the lens 701 to the end of the lens 701 to cover the entire outer frame 711 can be expressed by the following Expression (2) based on a width W of the outer frame 711 and the length a of the area 863 that is the overlapping portion of the scaled-down image data. The area 712 of the display module 702 is the area to which the scaled-down image data is output.

d=β+α+W (2)

When the condition of d=mβ is satisfied, the outer frame 711 becomes invisible to the viewer viewing from the front side. Meanwhile, the area 863 that is the overlapping portion of the length α being provided allows the viewer to see the video image without interruption up to the angle 803 of θ.

The focal length f of the lens 701 and a distance A (expressed as a negative value) from the display module 702 to the lens 701 are expressed by the following Expression (3).

A=f(β/d−1)=f(1/m−1) (3)

At this time, a distance B (expressed as a negative value) at which the virtual image 703 appears from the lens 701 is expressed by the following Expression (4).

B=A(d/β)=m*A (4)

The angle θ at which the overlapping area can be seen in this case is expressed by the following Expression (5).

tan θ=−α/B*d/β=−α/B*m (5)

When defining the angle 802 of θ″ at which the display area is visible behind the lens and an angle θ′ at which the overlapping area in the normal image area can be observed, and supposing the condition of |θ|=|θ″|=|θ′| is satisfied, the relation between the width a of the normal image area behind the lens 701 and the width a′ of the normal area corresponding to the overlapping area of the normal image area becomes |a′|=|a|. In this case, the relation of the width x of the scaled-down image area on the normal area side from the center of the lens 701 can be expressed by the following Expression (6).

mx=x+a−m*a (6)

Furthermore, based on the relation to the distance A between the lens 701 and the display module 702, the following Expression (7) can be derived.

|a|=|A|*tan|θ| (7)

From Expressions (6) and (7), the following Expression (8) can be derived.

x=|A|*tan|θ|*(1−m)/(m−1) (8)

By Expression (8), the length x for displaying the video image without interruption when viewed at an angle of up to the angle θ can be obtained. Here, the length x is a length from the center of the lens 701 and of the area to which the scaled-down image data is output.

As illustrated in FIG. 9, the display module 702 outputs the scaled-down image data and the normal image data, and thus the video image can be viewed without interruption between a position from the front side and a position inclined at the angle θ.

In the above-described embodiment, an example in two-dimensional display has been described. However, the video display devices 101 to 104 may be applied for a stereoscopic display.

The depth position of a virtual image of the enlarged image is different from the plane of the display. This causes disparity (difference in appearance) between the area that outputs normal image data and the area in which a scaled-down image is enlarged when an observing position is different. The deviation may be more conspicuous in the horizontal direction, in particular, because human eyes are separated into right and left.

However, on a stereoscopic video display device that reproduces a stereoscopic image with the disparity in the horizontal direction (and in the vertical direction in some cases), the use of the enlargement control with the above-described optical system reduces the widths of the seams visible to the viewer.

In the present modification, the optical element 701 corrects depth positions displayed for the deviation in depth only at the portions corresponding to the area in which the scaled-down image data is enlarged. Consequently, the deviation in depth (disparity) by the virtual image can be corrected.

The above-described embodiment and modification allow the viewer to recognize a video image without interruption even when viewed at an angle other than an angle from the front side with respect to the four-screen tiled display. Furthermore, because no resin (of the lens) is provided between the display module and the lens, the lens can be made thin and light in weight. This allows for the reduction in cost.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A video display device comprising:
a display module;
a frame provided to an outer circumference of the display module; and
an optical element provided on the frame and to a portion of an area on the display module including a border between the frame and the display module, and configured to enlarge a video image output from the display module in a direction from the display module towards the frame for an outer circumferential area including the frame and to enlarge the video image output from the display module in a direction from the frame towards the display module for an inner circumferential area on an inner side with respect to the outer circumferential area.

2. The video display device of claim 1, wherein, for an area to be enlarged by the optical element from among a display area displaying the video image, the display module is configured to output a video image which is scaled down by a scale-down factor corresponding to an enlargement factor of the area to be enlarged by the optical element.

3. The video display device of claim 2, wherein an area to which the display module outputs the scaled-down video image scaled down by the scale-down factor from among the display area displaying the video image is smaller than an area of the optical element to which the scaled-down video image is projected.

4. The video display device of claim 1, wherein the optical element is configured to enlarge a video image output from the display module in a horizontal direction and in a vertical direction as the direction from the display module towards the frame.

5. The video display device of claim 2, wherein the display module and the optical element are separated from each other by a predetermined distance.

6. The video display device of claim 1, wherein the optical element is configured to be capable of displaying a video image output from the display module in a stereoscopic manner and the video image is corrected for deviation in depth only at a portion corresponding to an area in which scaled-down image data is enlarged.

7. A video display system comprising a plurality of video display devices configured to be combined with each other to display video images linked with each other, the video display system comprising:
a display module;
a frame provided to an outer circumference of the display module; and
an optical element provided on the frame and to a portion of an area on the display module including a border between the frame and the display module, and configured to enlarge a video image output from the display module in a direction from the display module towards the frame for an outer circumferential area including the frame and to enlarge the video image output from the display module in a direction from the frame towards the display module for an inner circumferential area on an inner side with respect to the outer circumferential area.
